(19) United States
(12) Patent Application Publication
(10) Pub. No.: US 2010/0175945 A1
(43) Pub. Date: Jul. 15, 2010

(54) Emergency escape components with a glow-in-the-dark coating

(76) Inventor: James M. Helms, Fort Myers, FL (US)

Correspondence Address: KAREN TANG-WAI SODINI, 216 horseshoe drive, MARS, PA, 16046, US

(21) Appl. No.: 12/655,693

(22) Filed: Jan. 5, 2010

Related U.S. Application Data
(60) Provisional application No. 61/204,761, filed on Jan. 9, 2009.

(51) Int. Cl. B60K 28/12

(52) U.S. Cl. 180/281

(57) ABSTRACT

A vehicle emergency egress in which one or more components are provided with a luminescent coating, such as a phosphorescent coating. Exemplary vehicle emergency egress structures include a kick-out window, an emergency escape hatch, and a vehicle door, of which at least part of the emergency release structure, such as levers and handles, would be coated with a luminescent coating. Additionally, the perimeter of the emergency egress portal could be coated, to highlight the location of the emergency exit as well as its size.

### CROSS REFERENCE TO RELATED APPLICATION

Reference is made to and priority claimed from U.S. provisional application Ser. No. 61/204,761, filed on Jan. 9, 2009.

### FIELD OF THE INVENTION

The present invention pertains to the field of emergency escape exits from a vehicle. More particularly, the present invention pertains to coatings for such emergency escape exits.

### BACKGROUND OF THE INVENTION

In the event of a collision or other substantial force exerted on a vehicle, an occupant of the vehicle may not be able to easily locate a handle or release mechanism for an exit, such as a door or window, e.g. because it is at night, and power is lost to the vehicle so that any interior lighting is lost.

What is needed is a way to make emergency escape components, such as handles or release mechanisms, visible even in the dark, so that they can more easily be located.

### DISCLOSURE OF INVENTION

Accordingly, the invention provides a method by which handles and release mechanisms or other components of emergency exits are made visible in the dark, based on applying one or more coatings of a phosphorescent or other luminescent coating, and such components so coated.

### BRIEF DESCRIPTION OF THE DRAWINGS

The features and advantages of the invention will become apparent from a consideration of the subsequent detailed description presented in connection with accompanying drawings, in which:

FIG. 1 is a perspective view of an escape hatch for a vehicle with an escape lever mechanism, the release lever handle coated with a luminescent coating.

FIG. 2 is a perspective view of a window for a vehicle with a handle and pin window release mechanism with a luminescent coating.

FIG. 3 is a perspective view of a door latch system with a luminescent coating.

FIG. 4 is a perspective view of a vehicle door interior handle and door release mechanism with a luminescent coating.

### DRAWINGS LIST OF REFERENCE NUMERALS

The following is a list of reference labels used in the drawings to label components of different embodiments of the invention, and the names of the indicated components.

10 egress portal cover (vehicle escape hatch)
10a luminescent coating on lever release mechanism
10b luminescent coating surrounding perimeter of escape hatch
20 egress portal cover (vehicle window)
20a luminescent coating on a window release mechanism handle
20b luminescent coating on a window frame or window perimeter
20c luminescent coating on a window release mechanism pin
30 egress portal cover (vehicle door)
30a luminescent coating on a door handle/door release mechanism

### DETAILED DESCRIPTION

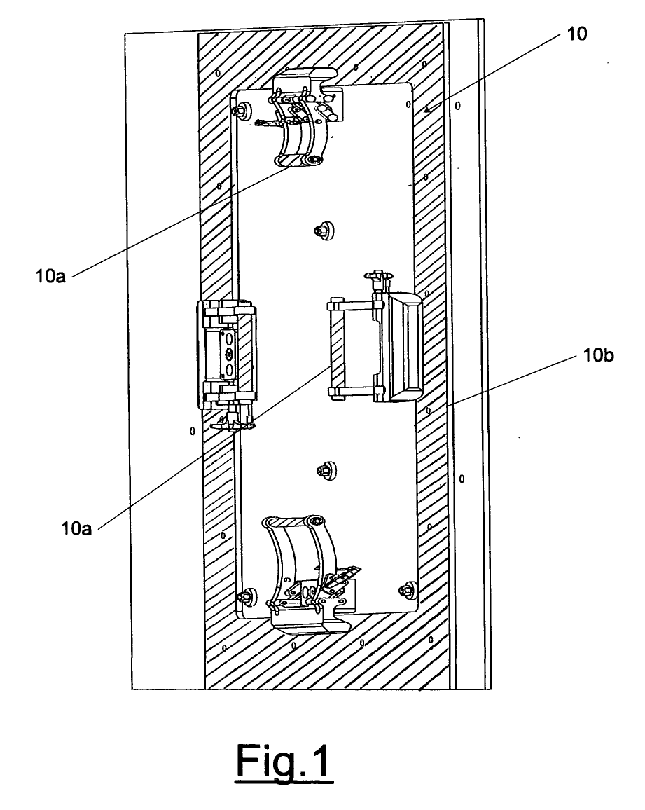

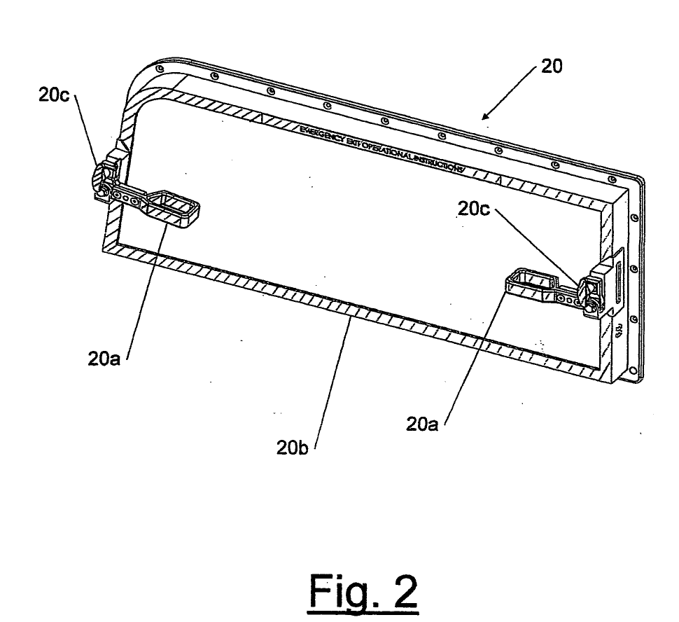

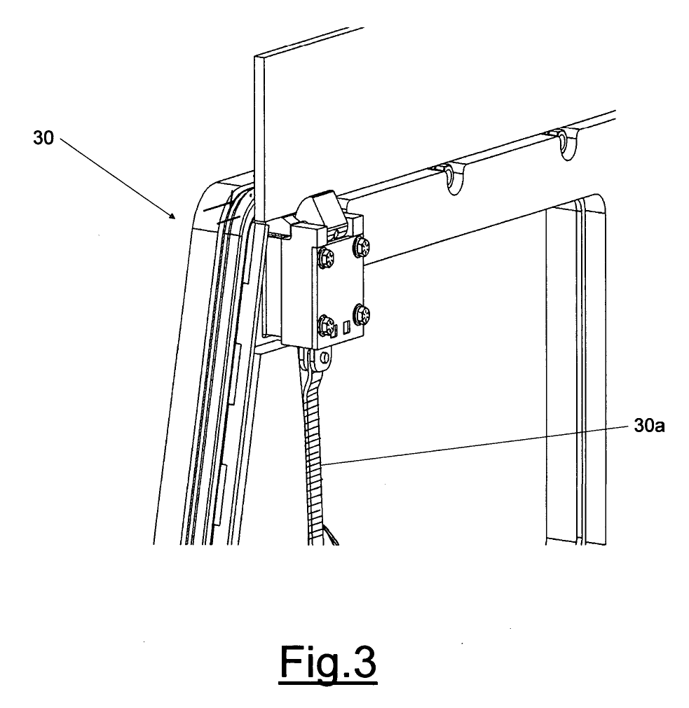

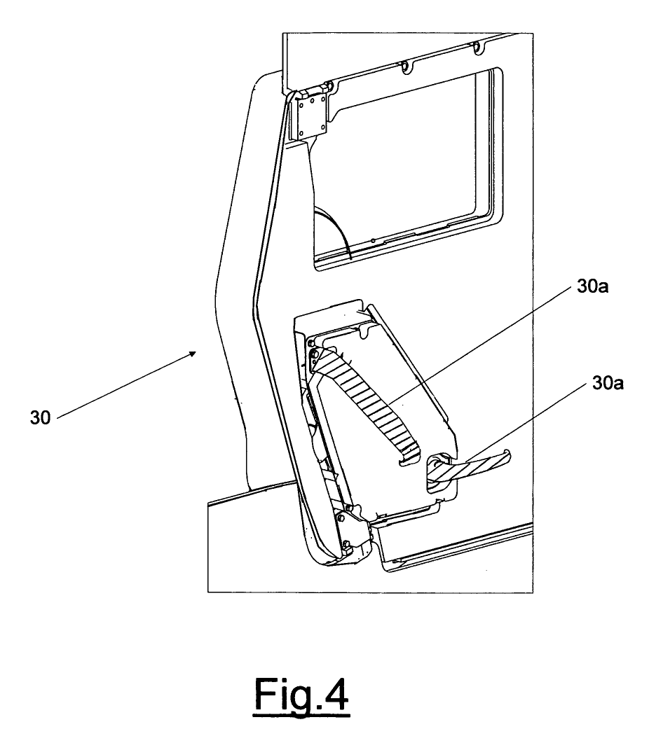

FIGS. 1-4 show advantageous embodiments of the invention, each figure comprising one or more components of an egress (i.e. a structure allowing egress) to be used for emergency escape from a vehicle, the component or components being coated, according to the invention, with a luminescent coating such as a phosphorescent coating. In FIG. 1, a handle 10a for a lever mechanism used to open an emergency escape hatch 10 features a luminescent coating. In FIG. 2, a frame 20b and at least one handle 20a and one pin 20c of a window 20 feature a luminescent coating. In FIG. 3, a door release mechanism for a vehicle door 30 features a latch with a pull handle, the handle 30a being coated with a luminescent coating. In FIG. 4, a vehicle door 30 features a luminescent coating on the door handle/release mechanism 30a.

In some embodiments where the components of an emergency egress of a vehicle are powder coated, a glow-in-the-dark powder coating additive is used to make the powder coated component phosphorescent. When used to coat emergency door handles 30a, for example, as shown in FIG. 4, the light during the day charges the pigments so that when it becomes dark outside, the handles glow and become visible.

Luminescent coatings are desirable, because the light emitted by the coating is a result of the excitation of atoms by energy other than heat, such as due to chemical changes within the coating. Common types of luminescent coatings include fluorescent coatings and phosphorescent coatings. Fluorescent-based coatings absorb and reemit energy immediately and cannot “store” energy. Phosphorescent coatings, however, release the light energy they absorb much more slowly and at a lower intensity, allowing the coatings to glow for extended periods of time.

A typical additive that can be used for this is based on Strontium Oxide Aluminate, which can glow up to ten times longer and has a much brighter initial afterglow as other more commonly used additives, such as Zinc Sulfide based pigments. It is non radioactive and free of hazardous materials. The coating is resilient against harsh weather so it can be charged and uncharged thousands of times.

According to the invention, all or part of a vehicle emergency egress (such as shown in FIGS. 1-4), such as a handle that must be turned or pulled or a lever disengaged to allow kicking out a window or removing a hatch, would be coated with a luminescent coating. Additionally, in some advantageous embodiments, a perimeter of the emergency egress could be coated with a luminescent coating, to help make more visible the egress opening and its size (e.g. as in FIG. 2 showing a coated window frame 20b, and as in FIG. 1 showing a coated perimeter of the vehicle frame 10b).

It is to be understood that the above-described arrangements are only illustrative of the application of the principles of the present invention. Numerous modifications and alternative arrangements may be devised by those skilled in the art without departing from the scope of the present invention.

What is claimed is:

1. An apparatus for enabling emergency egress from a vehicle, comprising:
a portal cover disposable in a vehicle egress portal, and a release mechanism attached to the portal cover so as to be accessible from inside the vehicle, for attaching the portal cover to the vehicle egress portal so as to cover the vehicle egress portal when the release mechanism is arranged in a first configuration, and for detaching the portal cover from the vehicle egress portal when the release mechanism is arranged in a second configuration, wherein at least a portion of the release mechanism comprises a luminescent coating.

2. The apparatus of claim 1, wherein at least some of the perimeter portions of the egress portal are coated with a luminescent coating.

3. The apparatus of claim 1, wherein a component of the luminescent coating is based on strontium oxide aluminate.

4. The apparatus of claim 1, wherein the coated emergency release mechanism is a handle.

5. The apparatus of claim 1, wherein the coated emergency release mechanism is a lever.

6. The apparatus of claim 1, wherein the luminescent coating is phosphorescent.

7. The apparatus of claim 1, wherein the vehicle egress portal is an opening for a kick out window.

8. The apparatus of claim 1, wherein the vehicle egress portal is an opening for a hatch.

9. The apparatus of claim 1, wherein the vehicle egress portal is an opening for a vehicle door.
